(19) United States
(12) Patent Application Publication
(10) Pub. No.: US 2007/0173297 A1
(43) Pub. Date: Jul. 26, 2007

(54) Apparatus and method for controlling keypad backlight of mobile phone

(75) Inventors: Min Sun Cho, Seoul (KR); Won Joo Park, Anyang-si (KR); Kyoung Ae Lim, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/638,598

(22) Filed: Dec. 13, 2006

(30) Foreign Application Priority Data
Jan. 24, 2006 (KR) 2006-0007070

(51) Int. Cl. H04B 1/38

(52) U.S. Cl. 455/574

(57) ABSTRACT

The present invention controls the keypad backlight of the mobile phone so as to avoid the waste of battery power, resulting in increases of the operation use time and user convenience. The method for controlling keypad backlight of a mobile terminal according to the present invention includes determining whether or to turn on the keypad backlight by comparing a present time with a sunrise time and a sunset time of a present country and season when an event requiring to turn on or off the keypad backlight occurs, and controlling the keypad backlight to be turned on or off based on the determination.

### PRIORITY

This application claims priority to an application entitled “Apparatus and Method for Controlling Keypad Backlight of Mobile Phone” filed in the Korean Intellectual Property Office on Jan. 24, 2006 and assigned Serial No. 2006-0007070, the contents of which are incorporated herein by reference.

### BACKGROUND OF THE INVENTION

1. Field of the Invention

The present invention relates generally to a mobile telephone, and in particular, to an apparatus and method for controlling a keypad backlight of the mobile telephone, which is capable of reducing power consumption.

2. Description of the Related Art

Typically, mobile terminals are portable devices working with battery power such as a mobile handset, a personal digital assistant (PDA), a laptop computer, and etc. Since these devices work with the support of the battery, it is critical to reduce the power consumption for increasing the battery life. Such mobile devices tend to be integrated in a mobile telephone. For example, a certain recent mobile phone is provided with a digital camera function and MP3 player function.

As the mobile phones being equipped with various functions, the mobile device is likely to consume much power. Accordingly, there has been much study for increasing the battery life of the mobile phone without recharge. One approach for reducing power consumption is to implement a circuit with low power consumption devices. Also, various techniques have been provided to reduce the power consumptions of the mobile phones. Most of these techniques have been focused on power control of the liquid crystal display (LCD), which consumes much power.

According to one example of such conventional techniques, a power saving method of mobile phone is applied to an optical detector. The optical detector detects the illumination and battery voltage and controls such that the LCD of the mobile phone enters the waiting mode when the illumination is less than a threshold value or the battery voltage is less than a predetermined voltage.

According to another example of such conventional techniques, a power saving method for mobile phone is applied to an illumination detector. The illumination detector detects the illumination around the mobile phone and switches on the LCD stepwise only when the user requests, resulting in reduction of the power consumption.

As the mobile phone becomes integrated with various functions, the keypad of the mobile phone is likely to have more keys. Such a keypad provides the user with an interface for supporting the various functions. Typically, the mobile phone is provided with a backlight right below the keypad so as to improve the readability of the keys, especially in a dark place or at night.

The backlight of the keypad is one of the main power consumptions of the mobile phone, thus unnecessary turning-on of the backlight wastes the battery power. For example, a certain mobile phone is designed to automatically turn on the backlight when an event occurs, i.e. a folder type phone is unfolded. The backlight of the keypad of this type of phone turns on regardless of day and night, resulting in a tremendous waste of the battery power.

In order to reduce the waste of battery power, a power saving mechanism is typically adopted for the backlight of the mobile phone. One approach for power saving is to configure such that the backlight turns on during the predetermined time. For example, the mobile can be set such that the backlight turns on just between 5 PM to 9 AM.

However, this conventional power saving mechanism makes a problem when the user tries to use the mobile phone in a dark place such as a warehouse or a theatre because the backlight does not turn on in the daytime. Also, since the conventional power-saving mechanism of the keypad backlight works without consideration of the changes of seasons, the backlight may be turned on before sunset especially in summer season, resulting in waste of battery power. Furthermore, since the power saving mechanism of the keypad backlight works in a fixed identical pattern even when the user roams other country in different time zone, the conventional power saving mechanism cannot effectively work, resulting in a waste of battery power.

### SUMMARY OF THE INVENTION

Accordingly, the present invention is directed to an apparatus and method that substantially obviates one or more problems due to limitations and disadvantages of the related art.

The present invention has been made in an effort to solve the above problem, and it is an object of the present invention to provide an apparatus and method for saving power of the mobile phone.

It is another object of the present invention to provide an apparatus and method for saving battery power by controlling the backlight of the mobile device.

It is still another object of the present invention to provide a method for saving battery power of the mobile device by automatically adjusting the brightness of the keypad backlight based on the luminance of the surroundings.

It is still another object of the present invention to provide a method for saving battery power by controlling keypad backlight in consideration of the sunrise and sunset of different countries and seasons.

In order to achieve the above objects, an apparatus for controlling keypad backlight of a mobile terminal according to the present invention includes a memory which stores a time table of sunrise and sunset times by country and season and conditions for turning on and off the keypad backlight, and a controller which retrieves the sunrise and sunset times of a present country and season, compares a present time with the retrieved sunrise and sunset time, and controls the keypad backlight to be turned on or off based on the comparison result, when an event requiring to turn on or off the keypad backlight occurs.

In another aspect of the present invention, a method for controlling keypad backlight of a mobile terminal includes determining whether or not to turn on the keypad backlight by comparing a present time with a sunrise time and a sunset time of a present country and season when an event requiring to turn on or off the keypad backlight occurs, and controlling the keypad backlight to be turned on or off based on the determination.

### BRIEF DESCRIPTION OF THE DRAWINGS

The accompanying drawings, which are included to provide a further understanding of the present invention and are incorporated herein and constitute a part of this application, illustrate embodiment(s) of the invention and together with the description serve to explain the principle of the invention. In the drawings;

FIG. 1 is a block diagram illustrating a mobile phone to which the present invention is to be adopted;

FIG. 2 is a flowchart for illustrating a procedure for configuring a mode of the keypad backlight according to an embodiment of the present invention;

FIG. 3A is a drawing for illustrating a keypad backlight configuration procedure according to an embodiment of the present invention;

FIG. 3B is a drawing for illustrating a keypad backlight configuration procedure according to another embodiment of the present invention;

FIG. 4 is a flowchart for illustrating an on/off operation of the keypad backlight according to the present invention;

FIG. 5 is a flowchart for illustrating a procedure for controlling keypad backlight based on luminance detections according to the present invention; and

FIG. 6 is a flowchart for illustrating a procedure for controlling keypad backlight based on the sunrise and sunset timetable according to the present invention.

### DETAILED DESCRIPTION OF THE PREFERRED EMBODIMENT

Preferred embodiments of the present invention will be described herein below with reference to the accompanying drawings. In the following description of the present invention, a detailed description of well-known functions and structures incorporated herein will be omitted when it may obscure the subject matter of the present invention. Certain terminology will be used in the following description for convenience, which is defined in consideration of the functions in the present invention such that it can be used in different meanings by the user's intention or convention. Accordingly, the definition should be understood on the basis of the usages and contents through the detailed description.

In order to simplify the explanation of the present invention, the preferred embodiments will be explained with a mobile phone having a keypad backlight mechanism. However, the present invention is not limited to the mobile phone but can be adopted to the mobile terminals such as a mobile handset, a PDA, an MP3 player, a digital camera, and etc. utilizing battery power.

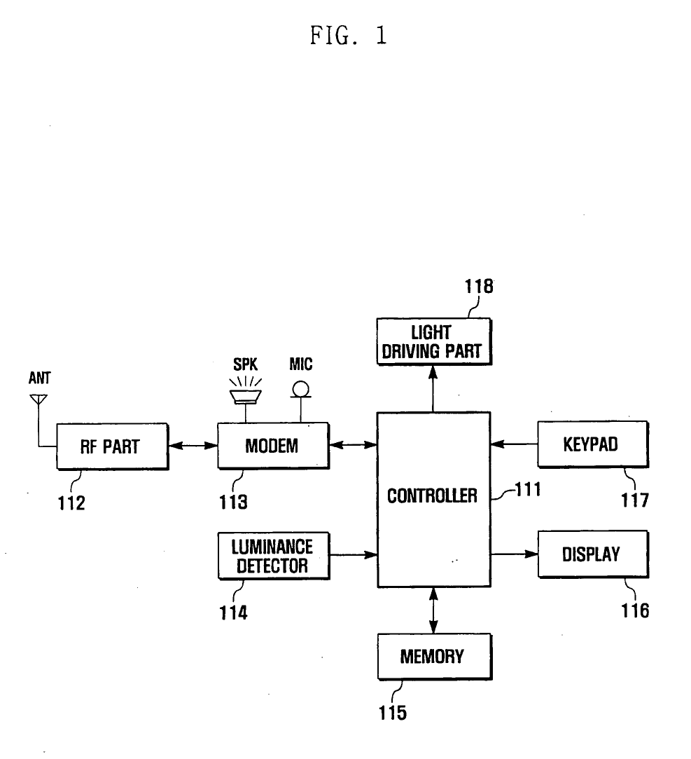

FIG. 1 is a block diagram illustrating a mobile phone to which the present invention is to be adopted. In FIG. 1, the battery and the power lines for supplying battery power are not shown.

Referring to FIG. 1, the mobile phone includes a controller 111, a radio frequency (RF) part 112, modem 113, a luminance detector 114, a memory 115, a display 116, a keypad 117, and a light driving part 118.

The controller 111 controls the overall operation of the mobile phone, especially the operation of the keypad backlight in the present invention. The normal operations of the mobile phone will not be described. And the operation for controlling the keypad backlight will be described with reference to the flowcharts hereinafter.

The RF part 112 converts the signal received through the antenna (ANT) into a baseband signal and then outputs the baseband signal to the modem (113) or converts the signal from the modem into the RF signal so as to transmit into the air. The modem 113 performs demodulation, deinterleaving, and decoding on the signal from the RF part 112 and outputs the signal through the speaker (SKP) if it is voice signal. Also, the modem 113 converts the voice signal inputted from the microphone (MIC) into digital signal and performs encoding, interleaving, and modulation on the converted digital signal and then outputs the signal to the RF part 112. The modem 113 receives various control signals required for communication operation from the controller 111 and performs encoding and modulation on the control signals to output to the RF part.

The luminance detector 114 detects the luminance of surroundings and provides the luminance information to the controller after converting the information into the digital signal. The memory 115 stores the programs for operating the mobile phone and a control program of the present invention. Also, the memory 115 includes the manipulation data set by the user, a table for storing the sunrise and sunset data by country and season, and the data for modes for operating the keypad backlight. Detailed operation of this will be described with reference to the drawings hereinafter.

Also, the memory 115 can store the information for displaying the present time using the information received from the base station if the terminal is cellular mobile phone. The present time means the information on time, date, month, and year. In case that it is difficult to obtain the present time with the information in the memory, the present time information should be implemented with an additional device or by the controller 111.

The display 116 includes of a liquid crystal display panel so as to provide the user with a Graphic User Interface (GUI). Also, the display 116 can be provided with a vibration motor and/or a lamp for notification of a call reception. The keypad 117 has a key matrix structure for generating values corresponding to the keys pushed by the user and provides the key values to the controller 111. The light driving part 118 is provided with a circuitry for operating the backlight positioned right below the keypad 117 and turns on and off the backlight according to the control signals from the controller 111.

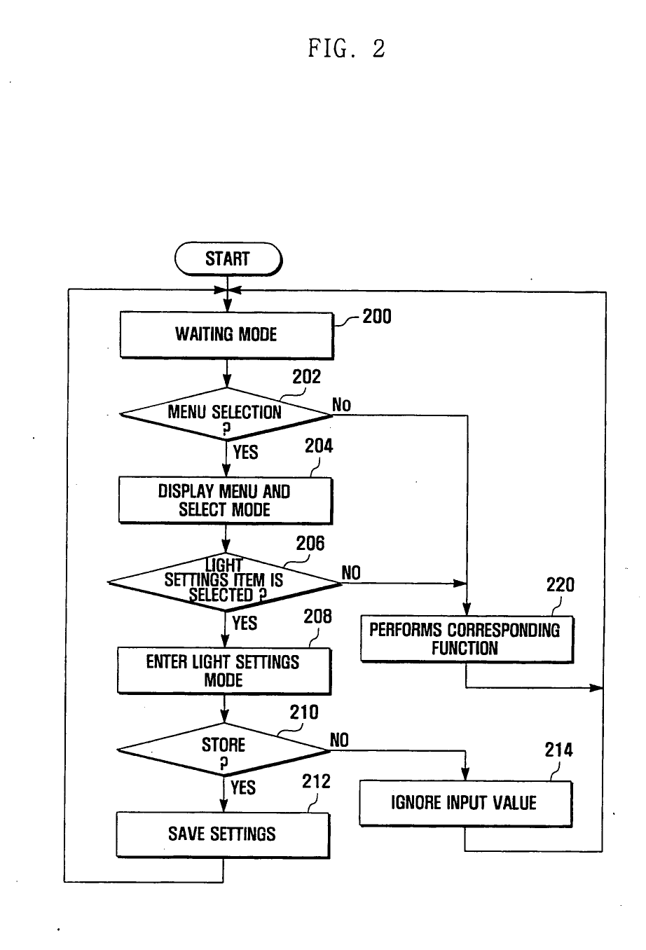

FIG. 2 is a flowchart for illustrating a procedure for configuring a mode of the keypad backlight according to the present invention.

Referring to FIG. 2, the controller 111 operates a waiting mode at step 200. In the waiting mode the mobile phone waits occurrence of predetermined events. For example, the controller 11 detects an occurrence of some events, such as a call reception, a short message reception, opening of the folder, or push of a predetermined button. If any of the events is detected, the controller 111 analyzes any selected menu. Here, the menu is a part for displaying the modes provided for changing the settings of various functions of the mobile phone.

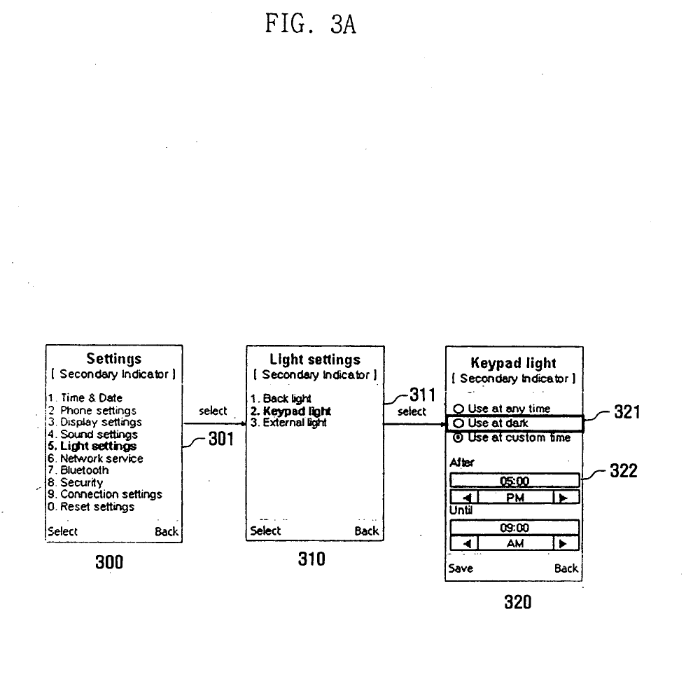

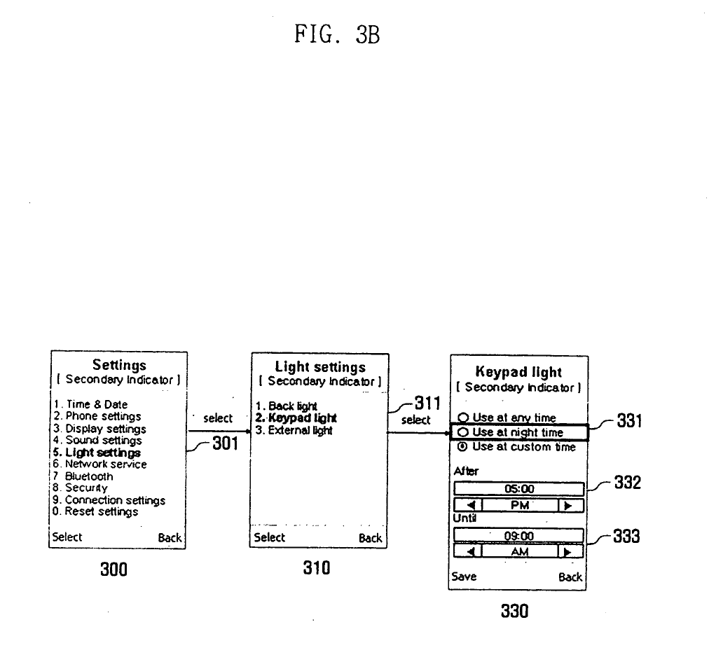

FIG. 3A is a drawing for illustrating a keypad backlight configuration procedure according to the present invention.

In FIG. 3A, a screenshot 300 as a main menu lists various submenus for setting various functions. Accordingly, if a submenu is selected at step 202, the controller 111 displays the selected submenu at step 204; otherwise, the controller performs a function corresponding to the key pushed by the user at step 220 and then ends the routine.

If a submenu is selected at step 202, the controller 111 displays setting item lists stored in the memory 115 as shown in screenshot 310 of FIG. 3A. Then, the controller 111 selects an item to be configured according to the key value inputted from the keypad at step 204. The selection of item is carried out by moving the cursor up and down using the direction keys of the keypad as shown in FIG. 3A. The item on which the cursor is positioned are shaded in gray. If the cursor moves on an item, sub-items corresponding to the item are displayed. Where the number of items to be displayed is more than the number of the lines of the display part, the items can be scrolled to be shown.

If a specific item is selected during the navigation of the menu, the controller 111 determines whether a light settings item is selected at step 206. If it is determined that the light settings item is selected, the controller enters the light settings mode at step 208, and otherwise, the controller performs a function corresponding to the button pushed by the user.

Now the light settings mode will be described with reference to FIG. 3A. As shown in a first screenshot 300, the settings menu lists the setting items, such that the controller 111 controls the displaying of the sub setting menu if one of the setting items is selected. If the Light settings item 301 is selected as in the screenshot 300, the controller 111 controls the displaying of a sub settings menu as shown in the screenshot 310. The sub settings menu lists the sub setting items, i.e., backlight, keypad light, and external light. If a keypad light item 311 is selected among the sub setting items as in the screenshot 310, the controller 111 controls the display part 116 so as to display the keypad light setting screen as in the screenshot 320. Through this keypad light setting screen the user can set the keypad backlight mode in a configuration part. (Not shown)

Four backlight operation modes are implemented in the configuration part of the present invention. In the first backlight operation mode the keypad backlight is turned on and off on the basis of the luminance of the surroundings detected by the luminance detector 114. In case that the luminance-based backlight operation mode is selected, i.e., the “Use at dark” option 321 is selected in the keypad light setting screen 320, the time adjustment function 322 for specifying the backlight operation time is disabled. In order to indicate the deactivation of the function, the time adjustment function object 322 can be shaded in gray. The deactivation of any function can be indicated in other manners as well as the shading effect.

A database (DB) is utilized in the second backlight operation mode. The second backlight operation mode will be described with reference to FIG. 3B.

FIG. 3B is a drawing for illustrating a keypad backlight configuration procedure according to another embodiment of the present invention. The screenshots for the settings menu and the sub settings menu are referred to by the identical reference numerals as in FIG. 3A except for screen shot 330 of the keypad light setting screen. That is, if the “Use at night time” option 331 is selected in the keypad light setting screen 330, the keypad backlight activation time is automatically determined according to the country. Also, the mobile phone can automatically obtain the time information from a wire/wireless network or a base station even while roaming such that the mobile terminal can utilize the time tables indicating the sunrise and sunset times by season. In case of selecting the “Use at nighttime,” it can be further required to select a country. The country selection process is not shown in FIG. 3B.

The third backlight operation mode is adopted for a manner mode which is an operation mode of the mobile phone for making neighbors uncomfortable. When the mobile phone is operating in the manner mode, there can be a procedure for configuring the priorities of the modes, i.e. the manner mode is prior to the user selection mode or the user selection mode is prior to the manner mode. The priorities of the modes can be determined during the manufacture of the mobile phone. Accordingly, when the manner mode is set, the keypad backlight is controlled to be on and off according to the priorities of the modes.

In the fourth backlight operation mode, at least two of the above modes can be adopted at the same time. That is, the keypad backlight can be controlled with the sunrise and sunset timetable based-backlight operation mode as well as the luminance-based backlight operation mode. Also, the combined backlight operation mode can be configured with the manner mode.

After the backlight operation mode settings are configured, the controller 111 determines whether a control signal for saving the configuration is inputted through the keypad 117. If the saving signal is inputted, the controller 111 checks the on/off conditions of the keypad backlight at step 212 and then returns to the step 200. If the input signal is a mode termination signal rather than the saving signal, the controller 111 bypasses the settings configured at step 208 and returns to the step 200.

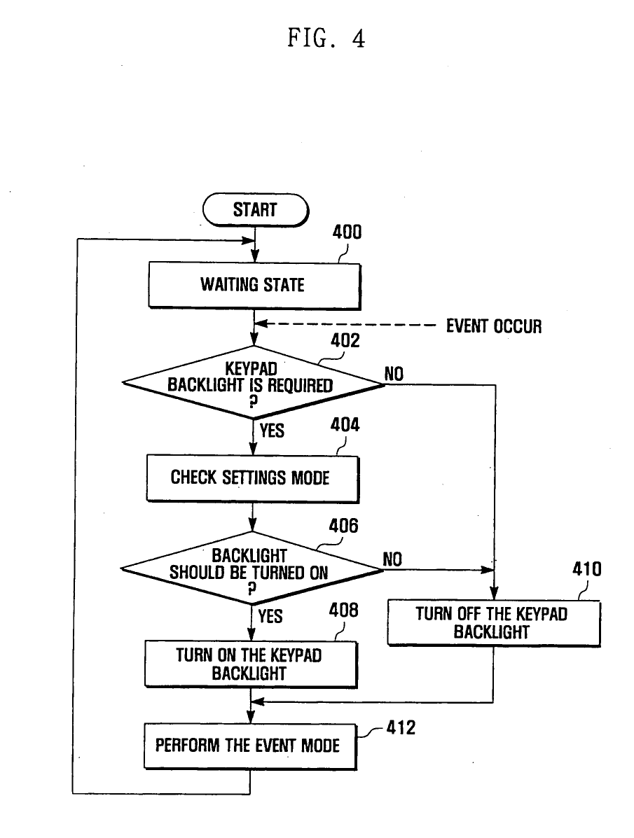

FIG. 4 is a flowchart for illustrating an on/off operation of the keypad backlight according to the present invention.

Referring to FIG. 4, the controller 111 maintains the waiting state at step 400 which is identical to the step 200 of FIG. 2. If a specific event occurs during the waiting state, the controller 111 determines whether the event is associated with the backlight operation at step 402. If it is determined that the event is associated with the backlight operation, the controller 111 reads the light settings configured at step 404 which is identical to step 208 of FIG. 2 and determines whether or not the event requires turning on the backlight at step 406.

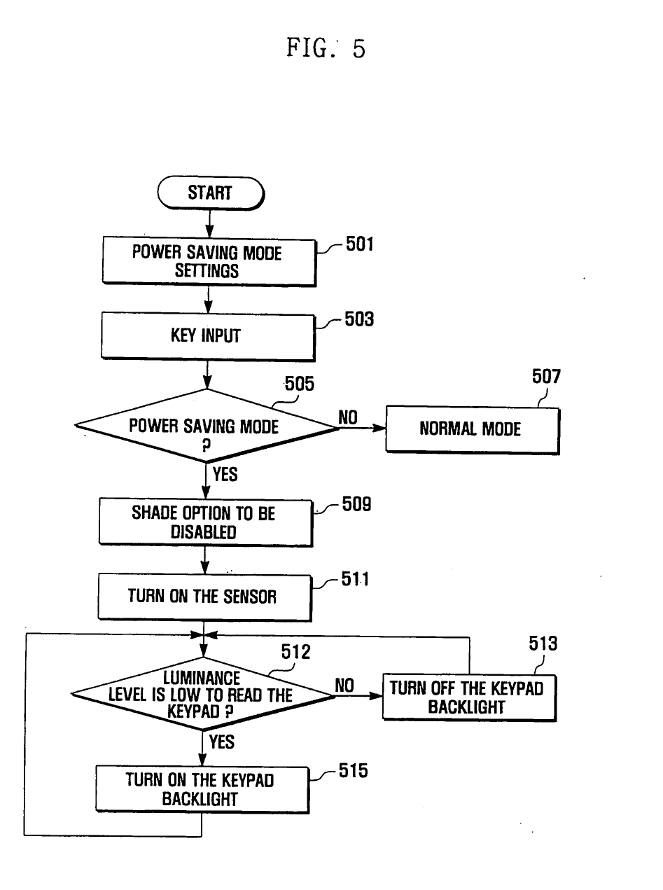

Referring to FIG. 5, the backlight operation will be explained in more detail. The luminance-based backlight operation mode is set through the steps 501 to 511 In FIG. 5, the controller 111 loads the previously configured settings through the steps 501 to 511, detects the luminance level of the surroundings, and determines whether to turn on or off the keypad backlight on the basis of the detected luminance level at step 512. As a result of the determination, the controller 111 turns on the backlight at step 515 or turns off the-backlight at step 513. The keypad backlight operation will be configured such that the backlight turns when the detected luminance level is less than a predetermined threshold value.

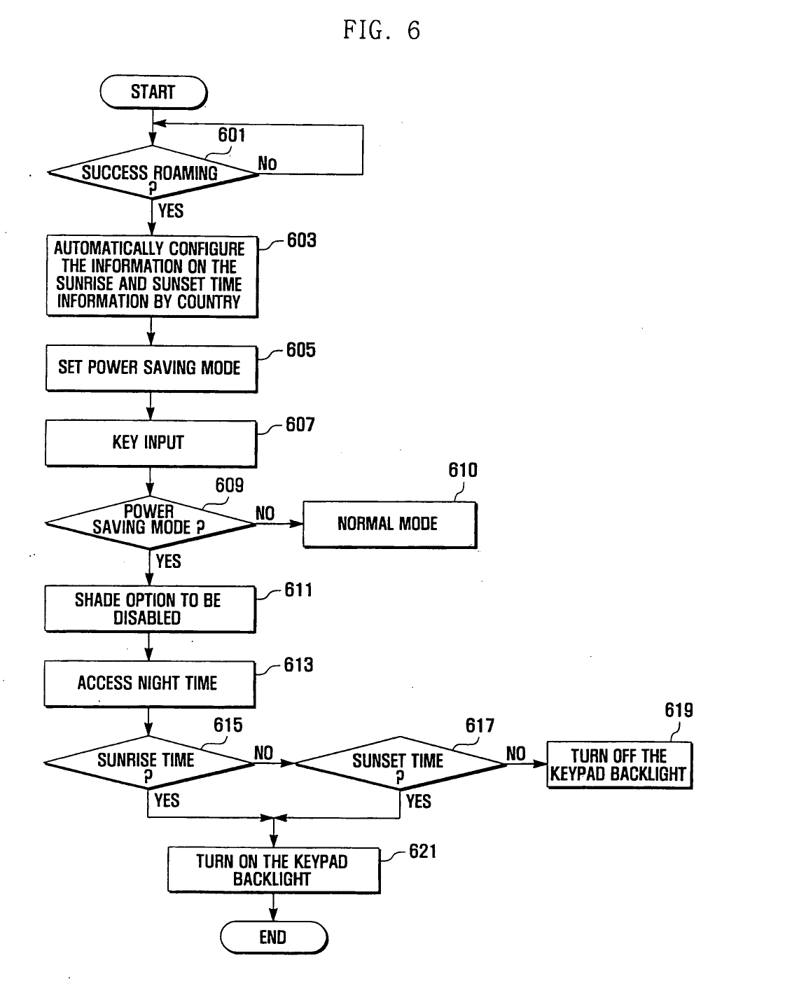

Referring to FIG. 6, the time table-based backlight operation mode is set through the steps 601 to 613. In FIG. 6, the controller 111 determines whether the present time is the sunrise or sunset times at steps 615 and 617, respectively, and turns on and off the keypad backlight at steps 619 and 621, according to the result of the determinations.

In case of using the two keypad backlight operation modes, the keypad backlight is configured to be turned on even when any of the conditions for the two modes is satisfied, i.e., the keypad backlight turns on in a dark place or gloomy weather even at daytime. In case of considering the manner mode which has much higher priority, the controller 111 first determines whether or not the manner mode operates and turns off the keypad backlight without considering other conditions when the manner mode operates.

If it is determined that the keypad backlight is to be turned on, the controller 111 controls the light driving part 118 for turning on the backlight at step 408. On the other hand, if it is determined that the keypad backlight is not need, the controller 111 outputs a light off signal to the light driving part 118 so as to maintain the turn-off state at step 410.

After completing the control of the backlight operation, the controller 111 performs the operation corresponding to sequentially followed events, i.e. a call reception or an opening of the folder.

As described above, the present invention controls the keypad backlight of the mobile phone so as to avoid the waste of battery power, resulting in increases of the operation use time and user convenience.

While the preferred embodiments of the present invention have been illustrated in the accompanying drawings and described in the foregoing description, it will be understood and apparent to those skilled in the art that the present invention is not limited to the embodiments disclosed, but is capable of numerous alternatives modifications variations, and substitutions without departing form the spirit and scope of the present invention as set forth and defined by the following claims.

What is claimed is:

1. An apparatus for controlling keypad backlight of a mobile terminal comprising:
a configuration part at which a user configure settings of a keypad backlight for saving power;
a luminance detector for detecting a luminance level of surroundings of the mobile terminal;
a memory for storing threshold value to be compared with the luminance level detected by the luminance detector for turning on and off the keypad backlight; and
a controller for comparing the luminance level with the threshold value and controlling the turning on or off the keypad backlight according to a result of the comparison, when an event requiring to turn on or off the keypad backlight occurs.

2. An apparatus for controlling keypad backlight of a mobile terminal comprising:
a memory for storing a time table of sunrise and sunset times by country season and conditions for turning on and off the keypad backlight; and
a controller for retrieving the sunrise and sunset times of a present country and season, comparing a present time with the retrieved sunrise and sunset time, and controlling the keypad backlight to be turned on or off based on a comparison result, when an event requiring to turn on or off the keypad backlight occurs.

3. The apparatus of claim 2, further comprising a luminance sensor for measuring a luminance level of surroundings and outputting the luminance level to the controller as digital information, and the controller for controlling the keypad backlight to be turned on when the luminance level is less than a predetermined threshold value or the present time is between the sunset and sunrise times of the present country and season.

4. The apparatus of claim 2, wherein the controller controls the keypad backlight to be turned off regardless of all the conditions if a manner mode is activated.

5. The apparatus of claim 3, wherein the controller controls the keypad backlight to be turned off regardless of all the conditions if a manner mode is activated.

6. An apparatus for controlling the keypad backlight comprising:
a luminance sensor for sensing surrounding luminance and converting the surrounding luminance into a digital luminance level; and
a controller for comparing the luminance level with a predetermined threshold level and turning on the keypad backlight when the luminance level is less than the threshold level.

7. A method for controlling keypad backlight of a mobile terminal comprising:
determining whether to turn on the keypad backlight by comparing a present time with a sunrise time and a sunset time of a present country and season when an event requiring to turn on or off the keypad backlight occurs; and
controlling the keypad backlight to be turned on or off based on the determination.

8. The method of claim 7, wherein the sunrise and the sunset times of the present country and season are updated when the mobile terminal moves into the country and receives a roaming service from a base station.

9. The method of claim 7, wherein the sunrise and the sunset times of the present country and season are automatically updated through a wire or wireless internet access.

10. The method of claim 7, further comprising:
detecting a luminance level of surroundings;
determining whether the luminance level is less than a predetermined threshold level; and
turning on the backlight if the luminance level is less than the threshold level.

11. The method of claim 7, wherein the keypad backlight is turned off regardless of all the conditions if a manner mode is activated.

12. The method of claim 8, wherein the keypad backlight is turned off regardless of all the conditions if a manner mode is activated.

13. A method of controlling keypad backlight of a mobile terminal, comprising:
detecting a luminance level of surroundings; and
controlling the keypad backlight to be turned on or off on the basis of the detected luminance level.

14. The method of claim 13, further comprising configuring a power saving mode through a setting screen displaying various options to be manipulated by the user, and at least one option is disabled if the option is not needed to be set.

15. A method of controlling keypad backlight of a mobile terminal, comprising:
configuring and checking a power saving mode to control turning on and off the keypad backlight;
checking whether information on sunrise and sunset time of a present country and season is updated;
determining whether to turn on the keypad backlight by comparing a present time with a sunrise time and a sunset time of a present country and season when an event requiring to turn on or off the keypad backlight occurs; and
controlling the keypad backlight to be turned on or off on the basis of the comparison result.

16. The method of claim 15, further comprising configuring a power saving mode through a setting screen displaying various options to be manipulated by the user, and at least one option is disabled if the option is not needed to be set.
